(19) United States
(12) Patent Application Publication
(10) Pub. No.: US 2026/0155850 A1
(43) Pub. Date: Jun. 4, 2026

(54) Transmitter, receiver, telecommunication system and associated method

(71) Applicant: THALES, Meudon (FR)

(72) Inventor: Aubin Michel LECOINTRE, TOULOUSE (FR)

(21) Appl. No.: 19/386,881

(22) Filed: Nov. 12, 2025

(30) Foreign Application Priority Data
Nov. 29, 2024 (FR) FR2413217

(51) Int. Cl. H04B 1/04

(52) U.S. Cl. CPC H04B 1/04; H04B 2001/0491

(57) ABSTRACT

This invention relates to a transmitter, adapted, given xᵢ+jx_{q}, and yᵢ+jy_{q}, respectively, a complex symbol resulting from a respective first and second data sequence, adapted to compose a respective first and second symbol to be transmitted in one of the following ways:
the first symbol is xᵢ+jyᵢ and the second symbol is x_{q}+jy_{q}; or
the first symbol is yᵢ+jx_{q} and the second symbol is xᵢ+jy_{q}; or
the first symbol is y_{q}+jx_{q} and the second symbol is yᵢ+jxᵢ; or
the first symbol is xᵢ+jy_{q} and the second symbol is yᵢ+jx_{q}.

### CROSS-REFERENCE TO RELATED APPLICATIONS

This application is a U.S. non-provisional application claiming the benefit of French Application No. 24 13217, filed on Nov. 29, 2024, which is incorporated herein by reference in its entirety.

### FIELD

This invention relates to a transmitter, a receiver, a telecommunication system, as well as the associated methods.

### BACKGROUND

The development of new telecommunication services requiring high data rates, the competition from terrestrial networks with the deployment of 400 Gbit/s technology and beyond, as well as the desire to reduce the digital divide by allowing every citizen to benefit from the same quality of service, wherever they may be, have caused a considerable increase in the transmission capacity needs of satellite operators, necessitating the deployment of additional systems.

Faced with such a demand for capacity, optical technologies comprise an alternative to traditional technologies operating by radio frequencies (RF) for very high-speed data transmission. In particular, free space ground-to-satellite optical communications are a promising solution for the next generation of very high throughput satellites.

However, the satellite optical channel presents several disadvantages. In particular, there is a strong signal degradation due to the composition of the atmospheric layers and turbulence. These phenomena cause severe fading, thus interrupting the transmission between a transmitter and a receiver for several milliseconds.

To compensate for this problem, the transmitter is equipped with very high-power optical amplifiers (HPOAs) to amplify the optical signal before free space transmission.

Furthermore, the transmitter uses two polarizations per wavelength to increase spectral efficiency: for a given wavelength, the signal includes two components, with one on a polarization axis X and the other on a polarization axis Y, each distinct from each other, with these components commonly referred to as polarization X and polarization Y of the signal. In this case, due to various technological constraints (technological maturity, spatialization of solutions, etc.) and practical constraints (high amplification gain, optical imperfections, etc.), the two components of the same wavelength with distinct polarization composing the optical signal at the considered wavelength, i.e., the two polarizations X or Y, are amplified by two different HPOAs in the transmitter. However, due to technological constraints, component reproduction inaccuracies, component disparities and imperfections and the environment (spatial, for example), etc., it is difficult to obtain the same amplification gain at a given time for the two HPOAs contributing to the transmission of the optical signal, which causes a power difference (and thus a performance difference) between the two polarizations X and Y of the final emitted optical signal. Moreover, this power gain is unpredictable, and can also vary over time.

More generally, in the overall architecture (mainly at the optical front end of the transmitter and that of the receiver), the optical signal passes through several items of equipment that do not guarantee perfect isolation between the two components: rotations of the polarization axes are thus observed at different locations, which has the effect of creating interference of each component on the other. For example, the optical fibers, the polarization beam splitters, or PBS, and the polarization beam combiners, or PBC, used in fiber optic telecommunication systems can also cause disparities in the amplitude of the two components of the signal, and reduce the transmission quality.

In the context of coherent transmission, the aim is to resolve this mixing of components, at reception level of the digital signal processing unit, typically in the equalization stage.

Even if this equalization brings an improvement, the less amplified component will always have degraded performance as compared to the other. Thus, for a given signal-to-noise ratio (total optical signal power of the two components compared to the total noise power), there is an imbalance in quality compared to the ideal case where the two amplifiers amplify with the same gain: the less amplified polarization will have degraded performance as compared to the ideal case. This is penalizing from a system point of view because the link budget is established based on the lower-performing polarization.

There are different types of techniques to compensate for this problem, such as:
signal processing algorithms such as a Stokes space transformation, for example: Stokes space is a mathematical representation of the polarization state of an electromagnetic wave; in the Stokes space, the polarization state of a wave is represented by a point in a four-dimensional space, where each dimension corresponds to a different polarization parameter; using Stokes coordinates, a matrix transformation is defined, which equalizes the power over the two polarizations;
polarization multiplexing and/or pre-coding: applying a pre-coding while distributing the two data streams over the polarizations.

These techniques have the disadvantage of adding processing complexity and significantly increasing memory requirements at the transmitter and receiver processing levels (especially at very high speeds). Moreover, Stokes space transformation-type algorithms present notable gains only at very high signal-to-noise ratios, which is not the case for spatial communications where signal-to-noise ratios are very low due to the great distance between the ground station and the satellite.

### SUMMARY

A goal of the invention is specifically to improve the transmission of digital information through an optical signal having two polarizations, in a simple manner and limiting the electrical power consumed.

More broadly, the goal of the invention is to improve the transmission of digital information between a transmitter and a receiver via two transmission chains through a telecommunication signal having two components, in a simple manner and limiting the electrical power consumed.

To this end, according to a first aspect, the invention relates to a transmitter, adapted to transmit two input digital data sequences to a receiver, comprising a first sequence and a second sequence, using two distinct transmission chains comprising a first and a second transmission chain, the transmitter comprising:
a transformation block adapted to transform the digital data of the first sequence, and of the second sequence, respectively, into complex symbols, each comprising an imaginary part and a real part;
a first transmission processing block adapted to receive, at the input, first complex symbols to be transmitted via the first transmission chain and to implement the transmission of said first complex symbols via said first transmission chain to the receiver;
a second transmission processing block adapted to receive, at the input, second complex symbols to be transmitted via the second transmission chain and to implement the transmission of said second complex symbols via said second transmission chain to the receiver;
given xᵢ+jx_{q} a complex symbol resulting from the transformation, by the transformation block, of the first sequence and given yᵢ+jy_{q} a complex symbol resulting from the transformation, by the transformation block, of the second sequence,
said transmitter is characterized in that it is adapted to compose the first complex symbols and second complex symbols to be transmitted by combining the symbols from the first sequence and the second sequence in one of the following ways:
the first symbol is xᵢ+jyᵢ and the second symbol is x_{q}+jy_{q}; or
the first symbol is yᵢ+jx_{q} and the second symbol is xᵢ+jy_{q}; or
the first symbol is y_{q}+jx_{q} and the second symbol is yᵢ+jxᵢ; or
the first symbol is xᵢ+jy_{q} and the second symbol is yᵢ+jx_{q}.

The invention thus enables reducing the impact on transmission quality of disparities occurring between the two transmission chains, such as between two polarizations of the optical signal. It solves the problem in a simple manner by exchanging, at transmission and reception, an I or Q component of one of the two signals to be transmitted on one of the transmission chains, (for example the transmission chain corresponding to the optical path of polarization X), with the respective I or Q component of the other of the two signals to be transmitted on the other of the transmission chains (for example the transmission chain corresponding to the optical path of polarization Y), where I is the so-called in-phase component, Q is the so-called quadrature component (Q) of a signal, with complex modulation on two polarizations (DP-QPSK), for example. Thus, the information to be transmitted is distributed evenly between the two polarizations which undergo different channels (and Signal to Noise Ratios, called SNR from the English, Signal-to-Noise-Ratio).

In embodiments, the transmitter comprises one or more of the following features, taken alone or in all technically possible combinations:
the first transmission chain corresponds to the selective transmission of a polarization component along only one of the distinct axes X or Y of an optical signal at a given wavelength λ and the second transmission chain corresponds to the selective transmission of a polarization component along the only other of the axes X or Y of said optical signal at the wavelength λ;
the transmitter is adapted to modulate the polarization component of the optical signal along the X axis based on the first complex symbols and to modulate the polarization component of the optical signal along the Y axis based on the second complex symbols,

the first transmission chain including a first optical amplifier of gain G1 adapted to selectively amplify the polarization component of the optical signal along the X axis,

the second transmission chain including a second optical amplifier of gain G2, distinct from G1, adapted to selectively amplify the polarization component of the optical signal along the Y axis.

The invention also relates to a receiver adapted to receive the signal emitted by the transmitter according to the first aspect of the invention and to convert it into output digital data.

In embodiments, the receiver comprises two reception processing blocks and is adapted to determine, in the first reception processing block, first complex symbols based on the received signal and, in the second reception processing block, to determine second complex symbols based on the received signal, the first and second complex symbols each comprising an imaginary part and a real part;
said receiver being adapted to compose complex symbols corresponding to a first sequence and complex symbols corresponding to a second sequence, by combining the first and second complex symbols in a manner inverse to the combination performed in the transmitter;
said receiver further including a transformation block adapted to transform the complex symbols corresponding to the respective first sequence or second sequence, into a respective first sequence of digital data or second sequence of digital data.

The invention also relates to a transmission system comprising such a receiver and the transmitter according to the first aspect of the invention.

The invention relates to a method of information transmission to transmit, to a receiver, two input digital data sequences comprising a first sequence and a second sequence, using two distinct transmission chains comprising a first chain and a second transmission chain, said method comprising the following steps implemented by the transmitter:
transforming the digital data of the respective first sequence or the second sequence into complex symbols each comprising an imaginary part and a real part;
receiving, at the input of a first transmission processing block, first complex symbols to be transmitted via the first transmission chain and implementing the transmission of said first complex symbols via said first transmission chain to the receiver;
receiving, at the input of a second transmission processing block, second complex symbols to be transmitted via the second transmission chain and implementing the transmission of said second complex symbols via said second transmission chain to the receiver;
wherein, given xᵢ+jx_{q} a complex symbol resulting from the transformation of the first sequence and given yᵢ+jy_{q} a complex symbol resulting from the transformation of the second sequence
said method is characterized in that it is adapted to compose the first complex symbols to be transmitted and second complex symbols to be transmitted by combining the symbols from the first sequence and the second sequence in one of the following ways:
the first symbol is xᵢ+jyᵢ and the second symbol is x_{q}+jy_{q}; or
the first symbol is yᵢ+jx_{q} and the second symbol is xᵢ+jy_{q}; or
the first symbol is y_{q}+jx_{q} and the second symbol is yᵢ+jxᵢ; or
the first symbol is xᵢ+jy_{q} and the second symbol is yᵢ+jx_{q}.

In embodiments, this method comprises one or more of the following features, taken alone or in all technically possible combinations:
the first transmission chain corresponds to the selective transmission of a polarization component along only one of the distinct axes X or Y of an optical signal at a given wavelength λ and the second transmission chain corresponds to the selective transmission of a polarization component along the only other of the axes X or Y of said optical signal at the wavelength λ;
the method comprising at least the following steps implemented by a receiver: reception of the signal emitted by the transmitter and conversion into output digital data;
the method comprising at least the following steps implemented by the receiver:
determining first complex symbols based on the received signal in the first reception processing block; and
determining second complex symbols based on the received signal in the second reception processing block, with the first and second complex symbols each comprising an imaginary part and a real part;
composing complex symbols corresponding to a first sequence and complex symbols corresponding to a second sequence, by combining the first and second complex symbols in a manner inverse to the combination performed in the transmitter;
transforming the complex symbols corresponding to the respective first sequence, or second sequence, into a respective first sequence of digital data or second sequence of digital data.

### BRIEF DESCRIPTION OF THE DRAWINGS

The invention will appear more clearly upon reading the following description, given solely by way of non-limiting example, and made with reference to the drawings wherein:

FIG. 1 is a representation of a transmission system in one embodiment of the invention,

FIG. 2 is a block diagram of the transmission system of FIG. 1,

FIG. 3 is a diagram of a part of the transmission system of FIG. 2,

FIG. 4 is a flowchart of an information transmission method in one embodiment of the invention, the method being implemented by the transmission system of FIG. 1

FIG. 5 is a diagram of a part of the transmission system of FIG. 2 in one embodiment of the invention,

FIG. 6 is a diagram of a part of the receiver of the transmission system of FIG. 2.

### DETAILED DESCRIPTION

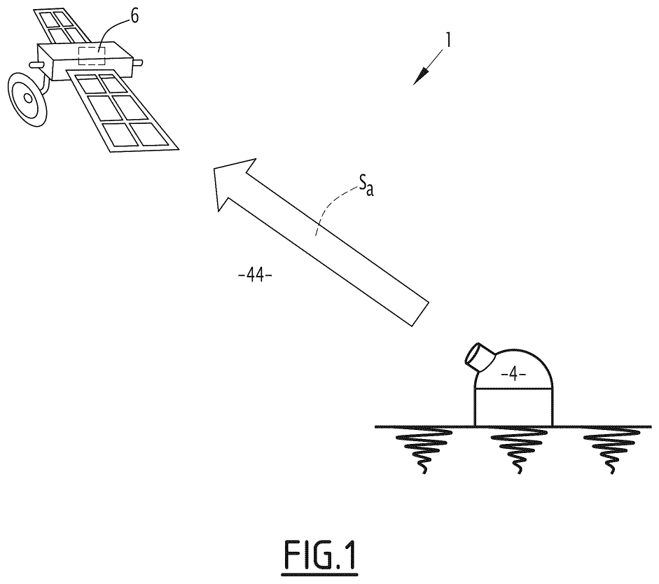

FIG. 1 represents a transmission system 1 in one embodiment of the invention.

The transmission system 1 comprises a transmitter 4 and a receiver 6.

In the considered example, the transmitter 4 is located on the ground, in a telecommunications station, for example, and the receiver 6 is in one embodiment embedded in an aircraft or a satellite.

In a variant, the transmitter 4 is embedded in an aircraft or a satellite and the receiver 6 is on the ground. In another variant, both the transmitter 4 and the receiver 6 are on the ground or embedded in satellite-type carriers or others.

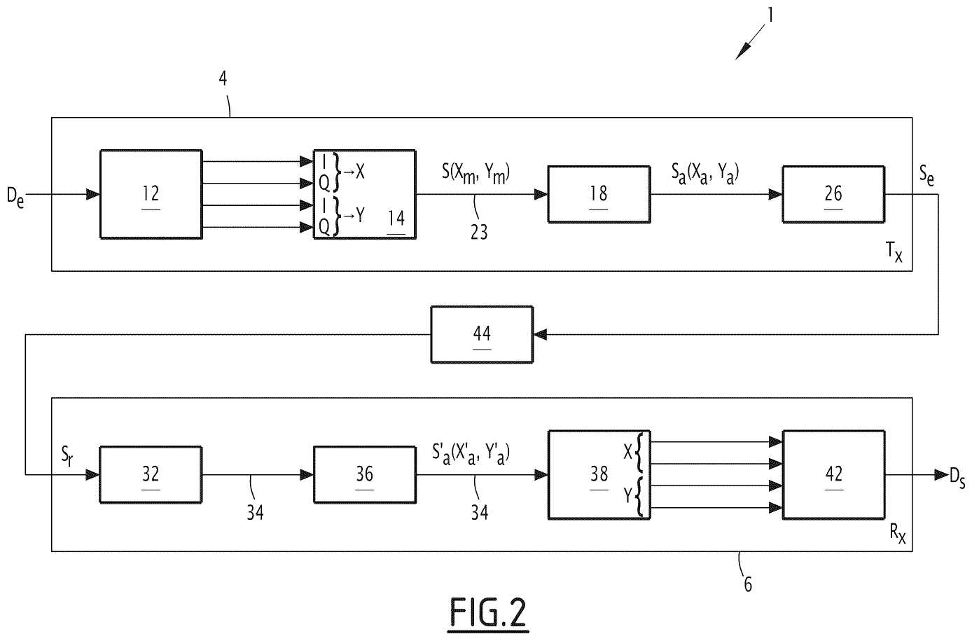

As shown in FIG. 2, the transmitter 4 in one embodiment comprises a digital processing module 12. The digital processing module 12 is implemented as a programmable logic component, for example, such as a FPGA (Field Programmable Gate Array), or an integrated circuit, such as an ASIC (Application Specific Integrated Circuit). In an unrepresented variant, the digital processing module 12 is implemented as software, stored in a memory and executable by a processor associated with the memory. Similarly, in an unrepresented variant, the digital processing module 12 is implemented by optical analog components.

The transmitter 4 further comprises an optical modulator 14, whose input is fed by the output of the digital processing module 12. The optical modulator 14 is a dual-polarization Mach-Zehnder interferometer, for example, comprising a laser source (one polarization along an X axis, one polarization along a Y axis). In the considered embodiment, for example, these polarization axes are orthogonal to each other.

The transmitter 4 further comprises an amplifier module 18, connected to the optical modulator 14.

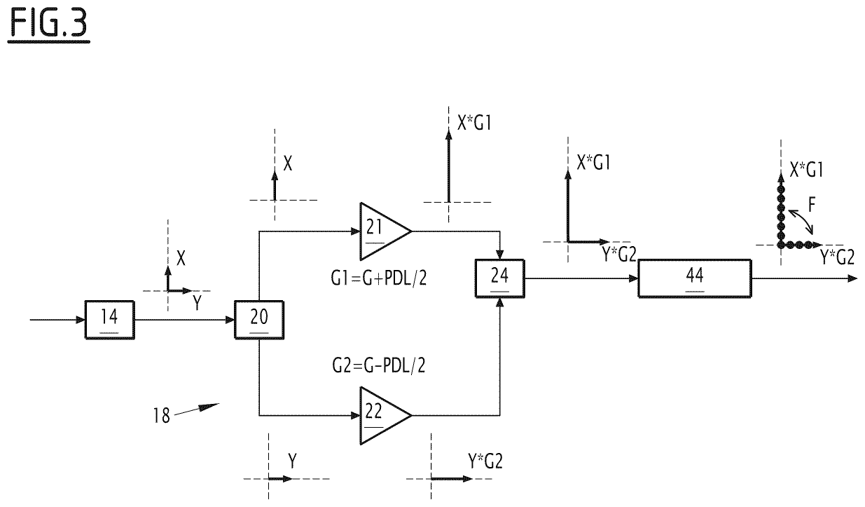

Referring to FIG. 3, the amplifier module 18 comprises a polarization beam splitter 20, also called a PBS. Advantageously, the polarization beam splitter 20 is a passive optical device. The polarization beam splitter 20 is configured to divide an optical signal into two components, one of the components corresponding to the first polarization X, the other component to the second polarization Y,

The amplifier module 18 comprises two optical amplifiers 21 and 22. The optical amplifiers 21 and 22 are very high-power optical amplifiers in one embodiment. The respective optical amplifier 21 or 22 is configured to amplify an optical signal passing through it with a respective gain G1 or G2. In one embodiment, the gains G1 and G2 are predefined and chosen by a manufacturer of the amplifier module 18. In theory, the gains G1 and G2 are chosen to be equal. However, due to imperfections in the optical amplifiers 21 and 22, material constraints or the spatial environment, the gains G1 and G2 are different in practice, and can vary over time. This results in polarizations with different powers, and thus differing performance. However, from a system and quality of service point of view, this is not desirable. Here, the polarization dependent loss (PDL) is the disparity in quality of the two polarizations here due to the difference in instantaneous amplification gain between the two HPOAs.

FIG. 3 illustrates the effects of gains on the polarizations X or Y during transmission. Random polarization rotations (symbolically represented in FIG. 3 by arrow F) are introduced by the various optical components used in the transmitter and receiver (for example, single-mode fiber SMF, front end FSO Tx and Rx, etc.) and by the propagation channel 44, causing a mixing of the two polarizations. In the case of coherent modulation, adaptive equalization algorithms such as the CMA (Constant Modulus Algorithm) will commonly be used to separate the two polarizations.

The amplifier module 18 further comprises a polarization beam combiner 24, also called PBC. The PBC 24 is a passive optical device in one embodiment. The PBC 24 combines the two components into a single optical signal in one embodiment.

In one embodiment, the optical modulator 14 and the amplifier 18 are connected to each other by polarization-maintaining fibers 23, also called PMF. In another embodiment, the fibers used are instead a single-mode type, called SMF.

Advantageously, the transmitter 4 comprises an optical head 26, also called an air interface module, and also known as an “optical front end” or OFE. The optical head 26 advantageously comprises one or more of the following devices: an optical device, a pointing device, a collimation device, a coupling device, or even turbulence compensation or pre-compensation devices. These devices are active or passive and are formed of arrangements of lenses and/or mirrors, for example.

Referring to FIG. 2, the receiver 6 in one embodiment comprises an optical head 32. This optical head 32 in one embodiment is configured to receive an optical signal and to focus it into an optical fiber 34 which in one embodiment connects the optical head 32 and an amplifier module 36, also comprised in the receiver 6. The amplifier module 36 is a low-noise amplifier in one embodiment.

The receiver 6 in one embodiment comprises an optical demodulator 38 and a digital processing module 42. In one embodiment, the amplifier module 36 and the optical demodulator 38 are also connected to each other by an optical fiber 34.

The optical demodulator 38 is configured to convert an optical signal into an electrical signal, representing the optical signal. In one embodiment, the digital processing module 12, the optical modulator 14 on one hand, and the optical demodulator 38 and the digital

processing module 42 on the other hand, correspond to each other. For example, the digital processing module 12 and the optical modulator 14 are configured to generate an optical signal according to coherent modulation, and the optical demodulator 38 and the digital processing module 42 are configured to perform operations that allow demodulating a coherent optical signal.

The digital processing module 42 is implemented as a programmable logic component, for example, such as an FPGA, or an integrated circuit, such as an ASIC. In an unrepresented variant, the digital processing module 42 is implemented as software, stored in a memory and executable by a processor associated with the memory. Similarly, in an unrepresented variant, the digital processing module 42 is implemented via optical analog components.

A method of information processing will now be explained, with reference to FIGS. 3, 4, 5, and 6. This method is implemented by the transmission system 1. It aims to transmit information from the transmitter 4 to the receiver 6 via two components of an optical signal at wavelength λ. The polarization axes of these components X or Y are distinct and as indicated above, in the considered embodiment as an example, the X axis is orthogonal to Y.

In one embodiment, the digital processing module 12 receives input digital data De during a reception step 102. The input digital data De is distributed on one hand into a first set of bits, called bits x, and on the other hand into a second set of bits, called bits y.

The digital processing module 12 processes the input digital data De during a conversion step into complex symbols 104. In one embodiment, during step 104, the digital processing module 12 also performs oversampling and/or shaping treatments, etc. This enables improving the transmission of digital information and limiting errors in the signal restored in the receiver 6, for example.

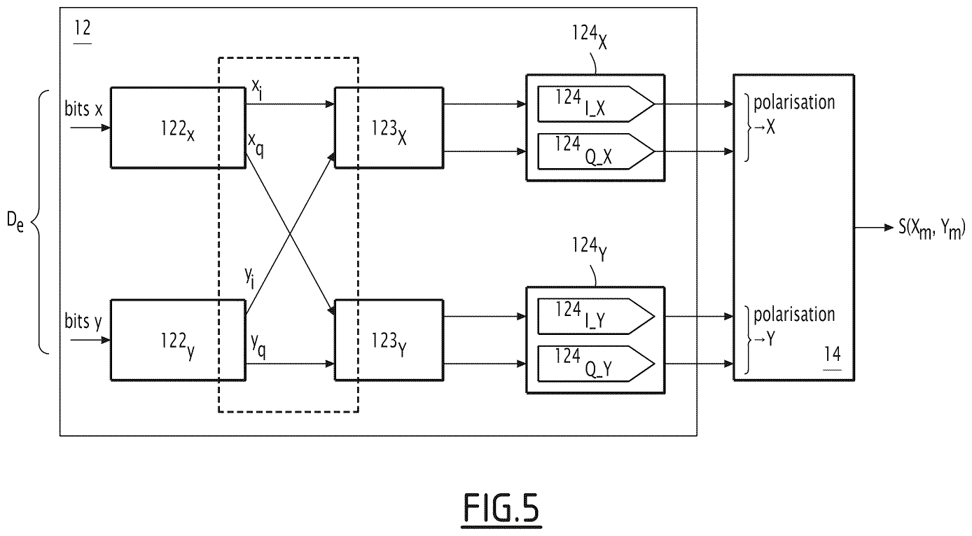

For example, referring to FIG. 5 schematically representing the digital processing module 12 and the modulator 14 in one embodiment, in the digital processing module 12, the bits x are received at the input of a block 122ₓ which determines complex symbols based on these bits x and delivers these complex symbols at the output. Such a symbol is written xᵢ+jx_{q}; it includes the real part xᵢ (or In-Phase Component) and the imaginary part x_{q} (or Quadrature-Phase Component).

In one embodiment, there are some of these symbols whose real part is non-zero and there are some whose imaginary part is non-zero.

Similarly, the bits y are received at the input of a block 122_{y} which determines complex symbols based on these bits y and delivers these complex symbols at the output. Such a symbol is written yᵢ+jy_{q}; these symbols thus include a real part yᵢ and an imaginary part y_{q} (and, there are some of these symbols whose real part is non-zero and there are some whose imaginary part is non-zero).

The determination of symbols from the bits x (similarly for the bits y) is performed by block 122ₓ (similarly by block 122_{y}) by QPSK modulation (Quadrature Phase Shift Keying),

for example, or by any complex modulation (QAM, M-PSK, PCS, etc.) that transposes digital data into complex symbols.

Then, in step 106, the digital processing module 12 determines modified complex symbols by swapping one of the imaginary and real parts of the symbols from block 122ₓ with one of the imaginary and real parts of the complex symbols provided by block 122_{y}.

Thus, in each modified symbol, either the imaginary part or the real part has been determined based on the set of bits x (and not based on the set of bits y), the other of said real and imaginary parts has been determined based on the set of bits y (and not based on the set of bits x).

This step 106 differs from the handling in the prior art, wherein the symbols from the bits x (i.e. the real and imaginary parts) were transmitted only on the polarization X, while the symbols from the bits y (i.e. the real and imaginary parts) were transmitted only on the polarization Y.

Whereas, in the example considered here, the digital processing module 12 determines modified complex symbols by swapping the imaginary part x_{q} of the symbols from block 122x with the real part yᵢ of the complex symbols provided by block 122 (cf. dashed box in FIG. 5).

Thus, the following digital (DSP) or analog (OFE) stages will process the component pairs (xᵢ; yᵢ) as a QPSK waveform on polarization X, thus with complex symbols xᵢ+j.yᵢ and the pair (x_{q}; y_{q}) a QPSK x_{q}+j.y_{q} for polarization Y (knowing that later, upon reception after the OFE Tx stages, propagation channel, OFE Rx and coherent DSP Rx, as described later, the components x_{q} and yᵢ will be re-exchanged, reordered to find their initial position). This solution enables taking advantage of polarization and quadrature diversity to offer two communication channels with equivalent SNRs in the presence of PDL.

In one embodiment, a filter 123_{X} applies a raised cosine root filtering RRC on the complex symbols xᵢ+j.yᵢ and a filter 123_{Y} applies an RRC filtering on the complex symbols x_{q}+j.y_{q}.

In a digital-to-analog conversion block 124_{X}, the respective digital real component xᵢ or analog imaginary component yᵢ is converted into a corresponding analog signal by a respective converter 124_{I_X} or 124_{Q_X}. The resulting analog signals representing the complex symbol xᵢ+j.yᵢ are provided to the input of the modulator 14 corresponding to the polarization path X.

In a digital-to-analog conversion block 124_{Y}, the respective digital real component x_{q} or analog imaginary component y_{q}, is converted into a corresponding analog signal by a respective converter 124_{I_Y} or 124_{Q_Y}. The resulting analog signals representing the complex symbol x_{q}+j.y_{q} are provided to the input of the modulator 14 corresponding to the polarization path Y.

The optical modulator 14 performs a modulation step 108 on these received signals. The modulation step 108 is a so-called dual polarization modulation step. The modulation step 106 comprises the generation of a modulated optical signal S, at wavelength λ, composed of the two polarizations Xₘ (X axis) and Yₘ (Y axis). The polarization Xₘ represents the data xᵢ+j.yᵢ. The second polarization Yₘ represents the data x_{q}+j.y_{q}.

The optical signal S is transmitted to the amplifier module 18.

In an optional embodiment, this transmission is performed via the polarization-maintaining fiber 23, to prevent unintentional polarization rotation.

An amplification step 110 is then performed by the amplifier module 18, to generate an amplified optical signal Saₐ from the optical signal S. In one embodiment, the amplification step 110 comprises sub-steps 112 to 116.

Sub-step 112 is a separation sub-step. Referring also to FIG. 3, the optical signal S received at the input is separated by the polarization beam splitter 20 into two optical components along the two polarization axes X or Y of the splitter 20. In one embodiment, the polarization axes of the splitter coincide with the polarization axes X and Y of the optical signal S, as visible in FIG. 3.

The polarization splitter 20 transmits the optical components to the amplifiers 21 and 22.

The amplifier 21 amplifies the component Xₘ (X polarization axis) with gain G1, thus generating an amplified component Xₐ (X polarization axis) and the amplifier 22 amplifies the component Yₘ (Y polarization axis) according to gain G2, thus generating an amplified component Yₐ.

The polarization beam combiner 24 performs sub-step 116, which is a combination sub-step. During the combination sub-step 116, the amplified components Xₐ and Yₐ are transmitted to the polarization beam combiner 24 which combines them to form the amplified optical signal Sₐ. This transmission takes place via an optical fiber, or, in a variant, in free space.

In one embodiment, the amplified optical signal Saₐ is then transmitted to the optical head 26, via an optical fiber, for example, or, in a variant, in free space. The optical head 26 performs an emission step 118 of the amplified optical signal Saₐ in a propagation medium 44, also called a propagation channel, to the receiver 6. In one embodiment, during the emission step 118, the optical head also performs one or more of the following operations, depending on the devices comprised in the optical head 26: a pointing operation, collimation, compensation, or pre-compensation, to improve the quality of the amplified signal Saₐ , and limit the losses or distortion caused by the amplified signal Saₐ emitted in the propagation medium 44.

The propagation medium 44 is an optical fiber, for example, or the atmosphere in the case of free space optical transmission, as represented in FIG. 1. Following the propagation of the signal via the medium 44, an optical signal is received by the receiver 6 during a reception step 120, via the optical head 32 in one embodiment. This optical signal received by the receiver 6 is called the received optical signal Sᵣ.

During the emission of the amplified optical signal Saₐ in the propagation medium 44, the amplified optical signal Saₐ is attenuated and its components Xₐ and Yₐ have mixed due to inhomogeneities of the propagation medium 44, for example, or, in the case of the atmosphere, due to turbulence or variations in the composition of the atmospheric layers. Thus, the amplified optical signal Saₐ as emitted by the transmitter 4 and the received optical signal Sᵣ by the receiver 6 are not identical, as represented in FIG. 3.

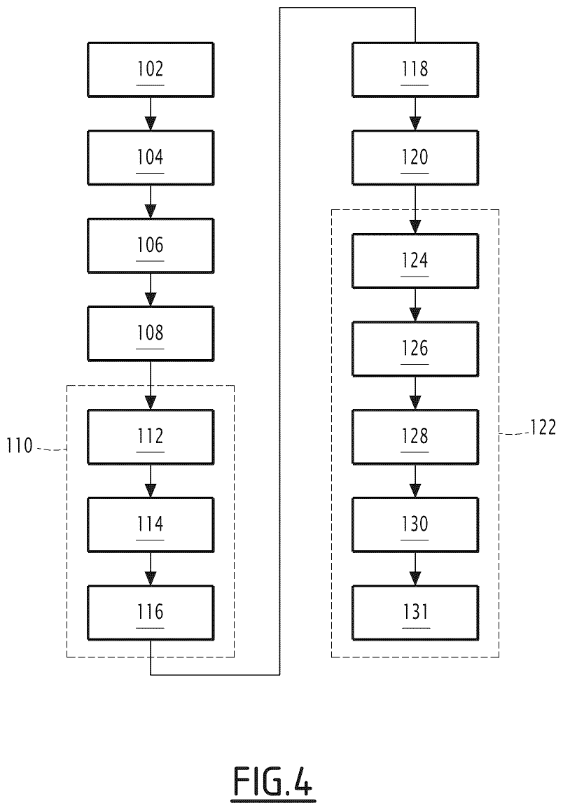

Referring to FIG. 4, the receiver 6 performs a set 122 of steps converting the received optical signal Sᵣ into output digital data Dₛ supposed to be equal to the input data Dₑ. For this, in one embodiment, the receiver 6 performs the following steps 124 to 130.

Referring also to FIG. 2, in one embodiment, the optical head 32 focuses the received optical signal Sᵣ during the focusing step 124 and transmits it to the amplification module 36 via the optical fiber 34.

During the amplification step 126, the amplification module 36 amplifies the received optical signal Sᵣ to form an amplified received optical signal Sₐ′.

The amplification module 36 transmits the amplified received optical signal Saₐ′ to the optical demodulator 38.

In the demodulation step 128, the optical demodulator 38 demodulates the amplified received optical signal Sₐ′: it extracts two demodulated analog signals, which it determines selectively based on the component X′ₐ of axis X on one hand (to the exclusion of the component Y′ₐ) and it extracts two demodulated analog signals, which it determines selectively based on the component Y′ₐ of axis Y on the other hand.

This demodulation is based on a coherent integrated receiver, also called ICR (Integrated Coherent Receiver), for example, comprising a local oscillator, a PBS, a 90° phase shifter, and four photodiodes (one per component Xi, Xq, Yi, Yq). The ICR enables the conversion of the optical signal into 4 RF signals that will be provided to the converters 224 mentioned below.

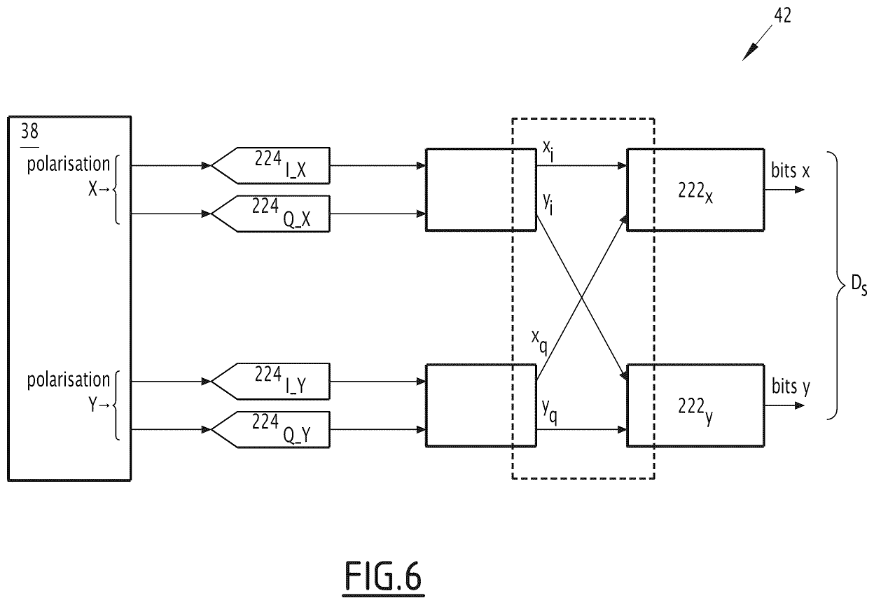

Referring to FIG. 6, one of these two demodulated signals from the component X′ₐ representing the real part of complex symbols is then converted to digital (component xᵢ) by a converter block 224_{I_X}; the other of these two demodulated signals from the component X′ₐ representing the imaginary part of complex symbols is also converted to digital (component yᵢ), by a converter block 224_{Q_X}.

Similarly, one of the two demodulated signals from the component Y′ₐ representing the real part of complex symbols, is then converted to digital (component x_{q}) by a converter block 224_{I_Y}; the other of the two demodulated signals from the component Y′ₐ representing the imaginary part of complex symbols (component y_{q}), is also converted to digital, by a converter block 224_{Q_Y}.

The real and imaginary parts of these complex coefficients from the respective polarization axes X or Y are provided to the input of the digital processing module 42.

In step 130, a reciprocal exchange of that made at the input between the components of the complex signals at step 106 is performed, before their provision to the blocks 222x and 222y of transformation of complex symbols into bits.

Thus, with the complex symbol from the X-axis polarization being xᵢ+j yᵢ and the complex symbol from the Y-axis polarization being x_{q}+j y_{q}, the values yᵢ and x_{q} are re-exchanged between them.

Then, in a bits transformation step 131, block 222x determines a set of bits x based on the complex symbols xᵢ+jx_{q} resulting from the exchange operation and similarly block 222y determines a set of bits y based on the complex symbols yᵢ+jy_{q} resulting from the exchange operation, in a manner corresponding to the inverse transformation performed in the transmitter. In the considered example where QPSK modulation had been used in the transmitter, the inverse operation of QPSK modulation is thus implemented.

The output digital data Ds comprising these sets of bits x and y are delivered at the output of the digital processing block 42, representing the input digital data Dₑ.

In the case where the received optical signal Sᵣ is a coherent optical signal, the digital processing module 42 in one embodiment implements an adaptive equalization algorithm, such as the constant modulus algorithm, or CMA, for example, a carrier and frame synchronization algorithm, or even decoding algorithms, to generate the output digital data Dₛ.

By means of this exchange between the I and Q components of the two polarizations X or Y as compared to the prior art, the power imbalance is compensated numerically without additional algorithmic complexity and two propagation channels with equivalent SNR and performance are guaranteed, even in the presence of PDL.

The invention ensures identical system performance (BER, mutual information, etc.) on the two polarizations and distributes the gain difference of the HPOA equitably on the two polarizations. Because even if the gain of the two HPOA is different, which thus introduces two propagation channels with two different SNRs, once re-exchanged in the receiver, the two sets of bits x and y will have seen an equivalent channel in terms of SNR and thus performance.

In the classical approach according to the prior art:
the set of bits x via polarization X operates on a channel with a signal-to-noise ratio of SNR+PDL/2;
the set of bits y via polarization Y operates on a channel with a signal-to-noise ratio of SNR-PDL/2;

With the invention:
the set of bits x operates on a channel with a signal-to-noise ratio of SNR+PDL/2 for the component xᵢ and SNR-PDL/2 for the component x_{q}, i.e. a total equivalent signal-to-noise ratio of SNR;
the set of bits y operates on a channel with a signal-to-noise ratio of SNR-PDL/2 for the component y_{q} and SNR+PDL/2 for the component yᵢ, i.e. a total equivalent signal-to-noise ratio of SNR.

The invention facilitates a system sizing that is no longer based on the worst-case scenario (i.e. the weakest polarization). This solution is very simple, inexpensive, and does not require modification of the optical front end. It offers excellent performance even for PDL greater than 9 dB.

To illustrate the obtained performance, an optical communication chain with dual polarization can be implemented with typical digital reception processing algorithms. The following figures represent the performance of an optical transmission in terms of mutual information (or, equivalently, the bit error rate) as a function of the signal-to-noise ratio, without and with the invention, for 3 and 6 dB of PDL.

For comparison, during tests, with a system operating according to the prior art, the performance related to the transmission of those of the data x or y via the less amplified polarization lags (by 0.9 and 1.8 dB for 3 and 6 dB of PDL, respectively) as compared to the average performance of the two (data x on polarization X and data y on polarization Y) in the absence of an adapted compensation mechanism; by implementing the mechanism according to the invention (swapping, as indicated, in step 106 at transmission and in step 130 at reception, we observe that the transmission performance of data x and data y are balanced (0.3 dB difference, regardless of the PDL).

The invention via the simple digital mechanism described enables insensitivity to PDL up to more than 9 dB without increased computational, digital, and analog complexity.

An exchange between the components x_{q} and yᵢ has been described above, but the invention is also valid for the three other types of exchanges between components xᵢ, x_{q}, yᵢ, and y_{q} that are also effective:
implementation no. 1: exchange x_{q} and yᵢ (xᵢ+jyᵢ for one polarization and x_{q}+jy_{q} for the other polarization); or
implementation no. 2: exchange xᵢ and yᵢ (yᵢ+jx_{q} for one polarization and xᵢ+jy_{q} for the other polarization);
implementation no. 3: exchange xᵢ and y_{q} (y_{q}+jx_{q} for one polarization and yᵢ+jxᵢ for the other polarization);
implementation no. 4: exchange x_{q} and y_{q} (xᵢ+jy_{q} for one polarization and yᵢ+jx_{q} for the other polarization).

The type of exchanges to be performed between components (which can vary over time in embodiments) is the same in the transmitter and the receiver; it is defined in a memory of these devices, for example, or coded in the frame information.

Thus, the transmission system 1 improves the quality of data transmission by optical signals by limiting the impact of amplification differences between the two optical components of the optical signal, in a simple manner, simply by ensuring that the real part and the imaginary part of the same symbol are not amplified by the same amplifier (more

generally by ensuring that they take distinct telecommunication paths). This mechanism does not require the introduction of a constellation rotation, digital pre-coding on the Tx side, decoding and equalization on the Rx side, or ML (maximum likelihood) detection.

In one embodiment, the optical signal comprises several wavelengths. The transmission chain is then modified as follows. The transmitter then comprises a digital processing module and an optical modulator per wavelength. A corresponding adaptation is made in the receiver 6.

The previously described method is then implemented by this processing chain for each wavelength.

In practice, a given wavelength corresponds to an optical signal whose spectral width is less than 1 nm, for example.

The invention has been described in an application of FSO feeder-type telecommunications by GEO satellite, but it is applicable for all types of optical communications (FSO feeder LEO, Optical Wireless Communication, hybrid RF-FSO, LiFi, terrestrial fiber telecommunications, etc.) or radio frequency (RF).

The invention has been presented in the case of an example where the gain imbalance was introduced as related by distinct amplifiers for the polarizations, but it is also applicable for all sources of imbalance between the paths, whatever the component (optical, analog, Radio Frequency (RF), or digital, etc.) that is the source: PBS, PBC, SMF/PMF fibers, LNOA, HPMUX, etc.

The invention has been described above in the case of a processing diversity based on the use of two polarizations of an optical signal. It can be implemented for any type of diversity implemented on two wired or wireless telecommunication chains, spatial or terrestrial, optical or RF, i.e., in all cases where it is desired to re-balance the performance between two transmission chains used. The imaginary or real parts are swapped between the symbols intended for two communication chains (for example, each corresponding to a distinct wavelength, when the diversity harnessed is based on the use of two wavelengths, or each corresponding to a distinct RF polarization when the diversity is based on the polarization of an RF signal, or the telecommunication chains corresponding to different telescopes, or to two distinct orbital angular moments (OAM)).

Any feature described for one embodiment or variant in the above can be implemented for the other embodiments and variants described above, as long as technically feasible.

1. A transmitter, adapted to transmit, to a receiver, two input digital data sequences (Dₑ) comprising a first sequence and a second sequence, using two distinct transmission chains comprising a first transmission chain and a second transmission chain, the transmitter comprising:
a transformation block adapted to transform the digital data of the respective first or second sequence into complex symbols, each comprising an imaginary part and a real part;
a first transmission processing block adapted to receive, at the input, first complex symbols to be transmitted via the first transmission chain and to implement the transmission of said first complex symbols via said first transmission chain to the receiver;
a second transmission processing block adapted to receive, at the input, second complex symbols to be transmitted via the second transmission chain and to implement the transmission of said second complex symbols via said second transmission chain to the receiver;
given xᵢ+jx_{q} a complex symbol resulting from the transformation of the first sequence by the transformation block, and given yᵢ+jy_{q} a complex symbol resulting from the transformation of the second sequence by the transformation block,
wherein said transmitter is adapted to compose the first complex symbols to be transmitted and the second complex symbols to be transmitted by combining the symbols from the first sequence and the second sequence in one of the following ways:
the first symbol is yᵢ+jx_{q} and the second symbol is xᵢ+jy_{q}; or
the first symbol is xᵢ+jy_{q} and the second symbol is yᵢ+jx_{q}.

2. The transmitter according to claim 1, wherein the first transmission chain corresponds to the selective transmission of a polarization component along only one of the distinct axes X or Y of an optical signal at a given wavelength λ and the second transmission chain corresponds to the selective transmission of a polarization component along the only other of the axes, X or Y, of said optical signal at the wavelength λ.

3. The transmitter according to claim 1, adapted to modulate the polarization component of the optical signal along the X axis based on the first complex symbols and to modulate the polarization component of the optical signal along the Y axis based on the second complex symbols,
the first transmission chain including a first optical amplifier of gain G1 adapted to selectively amplify the polarization component of the optical signal along the X axis,
the second transmission chain including a second optical amplifier of gain G2, distinct from G1, adapted to selectively amplify the polarization component of the optical signal along the Y axis.

4. A receiver, adapted to receive the signal emitted by the transmitter according to claim 1, and to convert it into output digital data.

5. The receiver according to claim 4, comprising two reception processing blocks and adapted to determine, in the first reception processing block, first complex symbols based on the received signal and to determine, in the second reception processing block, second complex symbols based on the received signal, the first and second complex symbols each comprising an imaginary part and a real part;
said receiver being adapted to compose complex symbols corresponding to a first sequence and complex symbols corresponding to a second sequence, by combining the first and second complex symbols in a manner inverse to the combination performed in the transmitter
said receiver further including a transformation block adapted to transform the complex symbols corresponding to the respective first sequence or second sequence, into a respective first sequence or second sequence of digital data.

6. A tele-transmission system comprising the transmitter according to claim 1 and the receiver according to claim 4.

7. An information transmission method to transmit, to a receiver, two input digital data sequences comprising a first sequence and a second sequence, using two distinct transmission chains comprising a first transmission chain and a second transmission chain, said method comprising the following steps implemented by the transmitter:
transforming the digital data of the respective first sequence or second sequence into complex symbols, each comprising an imaginary part and a real part;
receiving, at the input of a first transmission processing block, first complex symbols to be transmitted via the first transmission chain and implementing the transmission of said first complex symbols via said first transmission chain to the receiver;
receiving, at the input of a second transmission processing block, second complex symbols to be transmitted via the second transmission chain and implementing the transmission of said second complex symbols via said second transmission chain to the receiver;
wherein, given xᵢ+jx_{q}, a complex symbol resulting from the transformation of the first sequence and given yᵢ+jy_{q}, a complex symbol resulting from the transformation of the second sequence
said method is characterized in that it is adapted to compose the first complex symbols to be transmitted and the second complex symbols to be transmitted by combining the symbols from the first sequence and the second sequence in one of the following ways:
the first symbol is yᵢ+jx_{q} and the second symbol is xᵢ+jy_{q}; or
the first symbol is xᵢ+jy_{q} and the second symbol is yᵢ+jx_{q}.

8. The information transmission method according to claim 7, according to which the first transmission chain corresponds to the selective transmission of a polarization component along only one of the distinct axes X or Y of an optical signal at a given wavelength λ, and the second transmission chain corresponds to the selective transmission of a polarization component along the only other of the axes X or Y of said optical signal at the wavelength λ.

9. The information transmission method according to claim 7, the method comprising at least the following steps implemented by a receiver: reception of the signal emitted by the transmitter and conversion into output digital data.

10. The information transmission method according to claim 9, the method comprising at least the following steps implemented by the receiver:
determining, in the first reception processing block, first complex symbols based on the received signal; and
determining, in the second reception processing block, second complex symbols based on the received signal, the first and second complex symbols each comprising an imaginary part and a real part;
composing complex symbols corresponding to a first sequence and complex symbols corresponding to a second sequence, by combining the first and second complex symbols in a manner inverse to the combination performed in the transmitter;
transforming the complex symbols corresponding to the respective first or second sequence into a respective first sequence of digital data or second sequence of digital data.
